(19) United States
(12) Patent Application Publication
(10) Pub. No.: US 2016/0369483 A1
(43) Pub. Date: Dec. 22, 2016

(54) Waste Water Re-Directing System

(71) Applicant: Leonard Wade, Long Beach, CA (US)

(72) Inventor: Leonard Wade, Long Beach, CA (US)

(21) Appl. No.: 15/189,370

(22) Filed: Jun. 22, 2016

Related U.S. Application Data
(60) Provisional application No. 62/182,944, filed on Jun. 22, 2015.

(51) Int. Cl. E03B 1/04; C02F 1/76

(52) U.S. Cl. CPC E03B 1/042; C02F 1/76; A01G 25/00

(57) ABSTRACT

A waste water re-directing system that comprises at least one initial plumbing pipe, a fluid pump, an overflow pipe and a secondary plumbing pipe. Waste water flowing from a bathroom structure such as a bathtub or shower flows into the initial plumbing pipe. The water then flows into and out of the fluid pimp. From the pump the water flows into and through the secondary plumbing pipe, which terminates at a spigot placed at a location outside the dwelling adjacent or near plant life. A watering device such as a sprinkler is attached to the spigot and the water is applied onto the plant life. Excess water flows into the overflow pipe and back into a city main pipe. If desired, a timer can be used to selectively control hen the system is operational. Also, the waste water can be chemically treated to de-contaminate the water.

The invention generally pertains to water systems, and more particularly to a waste water re-directing system (WWRS) that utilizes waste water from a bath structure such as a bathtub and/or shower to provide water tor an outside lawn or other plant-life.

### BACKGROUND ART

Dwellings, such as houses and apartments, throughout the developed world typically have at least one interior bathtub, shower or combination bathtub and shower. Water for bathtubs and/or showers is usually provided from a city's main water line and is paid for depending on the amount of water used by the homeowner, renter or other resident(s).

The water enters a bathtub through a spigot and a shower through a showerhead, and the water exits through a drain to a city's return water line. Depending on how frequently a person(s) uses a bathtub or shower, and how long they spend each time, a significant amount of waste water is provided.

Water has been referred to as our greatest natural resource, and today in many parts of world, water has become scarce. Even in the richer countries water conservation is now mandatory in certain cities and other locations.

What is needed is a way to optimize water usage by providing a means of utilizing the waste water produced from bathtubs and/or showers. By re-directing the waste water, other uses could be realized. One of the most obvious uses would be to re-direct the waste water to provide water or lawns, trees and other plant-like, which typically utilizes the same, valuable clean water that flows through a city's main water line. By re-directing the waste water to lawn and other plant-life, the effective use of water is doubled and a significant amount of monetary savings can be realized.

A search of the prior art did not disclose any literature or patents that read directly on the claims of the instant invention. However, the following U.S. patents are considered related:

| PATENT NO. | INVENTOR | ISSUED |
|---|---|---|
| 4,723,408 | Hewlett | 26 Jan. 1988 |
| 5,133,622 | Hewlett | 28 Jul. 1992 |
| 2008/0250709 | Shepard-Wilson | 16 Oct. 2008 |

The U.S. Pat. No. 4,723,408 patent discloses a water distribution system including an irrifluent pipe disposed below the soil surface for dispersing water or treated waste water at a controlled rate. The irrifluent pipe includes an inner fluid conduit having apertures therethrough and an outer cover. The outer cover is attached to the inner fluid conduit so that the dispersed fluid slowly seeps into the ground.

The U.S. Pat. No. 5,133,622 patent discloses a water distribution system that includes a distribution conduit and an irrifluent pipe disposed on or below ground for dispersing water at a controlled rate. A first pump connected to the distribution conduit passes the water through the main delivery conduit and through apertures in the irrifluent pipe. A return conduit is disposed in fluid communicating relation to the irrifluent pipe, and a second pump is connected in fluid flow relation to the return conduit.

The 2008/0250709 publication discloses a system that is gravity forced for distributing waste water to plant material. The system comprises a water receiving means, a lint trapping means within the receiving means inlet and outlet devices of the receiving means and an irrigation means for transporting water from the receiving means to specified parts of a garden.

For background purposes and indicative of the art so which the invention relates, reference may be made to the following remaining patents found in the patent search.

| PATENT NO. | INVENTOR | ISSUED |
|---|---|---|
| 4,554,690 | Knapp, et al | 26 Nov. 1985 |
| 8,702,077 | Shah | 22 Apr. 2014 |
| 2006/0130898 | Esmailzadeh | 22 Jun. 2006 |
| 2014/0262998 | Wagner | 18 Sep. 2014 |
| 2012/0199220 | Knepp | 9 Aug. 2012 |

### DISCLOSURE OF THE INVENTION

In its basic design, the waste water re-directing system is comprised of plumbing pipes and a fluid pump. Waste water is re-directed from a bathroom structure such as a bathtub or shower. The waste water flows through the pipes to the fluid pump, from where the water is directed into and through another pipe, which terminates at a spigot outside the dwelling or other building.

Optimally, the spigot is adjacent or near plant like. A watering device such as a sprinkler head is attached to the spigot, typically via a water hose, and the waste water from the dwelling is used to water the plant life.

The system is adaptable for use with multiple bathroom structures and for dwellings of any size. If desired a timer can be included to selectively control when the system is operational. Additionally, to improve the overall quality of the water exiting from the systems, a water treatment chemical that is used in combination with a water treatment tank, can be utilized. The chemical, which is preferably chlorine, significantly improves the quality of the water by removing contaminants which could be harmful. Waste water from a bathroom structure such as a bathtub or shower is typically safe for watering plant life, but the additional water treatment provides definite clean water that can be used for multiple purposes.

The system can be used to water small areas such as single family dwelling lawns, or the system can be up-scaled and used to water large areas such as sport stadiums. The only difference between a small area and a large area is the amount of plumbing required, the strength of the fluid pump, and the amount of water treatment (if applicable).

In view of the above disclosure, the primary object of the invention is to provide a waste water re-directing system that allows typical bath or shower waste water to be re-directed for watering plant life outside of a dwelling or building.

In addition to the primary object of the invention, it is also an object of the invention to provide a waste water re-directing system that:
is easy to install,
is easy to use,
can be automatically controlled by a timer or other means,
significantly reduces the amount of waste water, as well as homeowner water usage costs,
can be implemented in small or large cities or towns,
can be used in any/all types of dwelling or buildings, wherever there is indoor bath structure plumbing,
can be sold as a user-installable kit, or can be built into new dwellings/buildings,
requires minimal maintenance,
can increase the value of a property, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevational view of a waste water re-directing system (WWRS) located in a dwelling having one combination bathtub and shower.

FIG. 2 is an elevational view of the WWRS located in a dwelling having two combination bathtub and shower.

FIG. 3 is an elevational view of the WWRS located in a dwelling having separate bathtub and shower, and including a chemical treatment container and a water treatment tank.

### BEST MODE FOR CARRYING OUT THE INVENTION

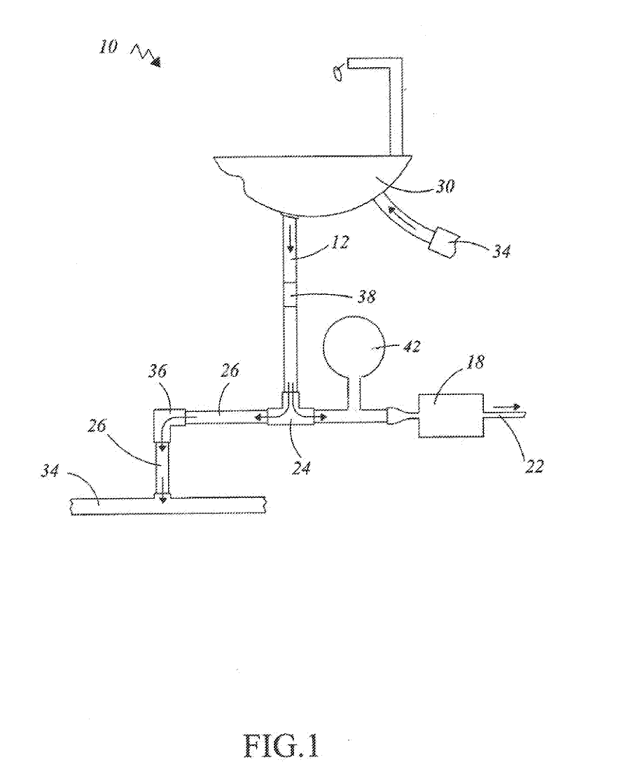

The best mode for carrying out the invention is presented in terms that disclose a preferred embodiment of a waste water re-directing system. Throughout the developed world, most dwellings such as houses and apartments, each have at least owe bathtub and/or shower. Water for bathtubs and showers is typically supplied from a city's water lines. Once used, the water flows out through a bathtub's or shower's drain. The instant waste water re-directing system 10 (“WWRS ID”), as shown in FIGS. 1 -3, and which is known as the “Back to Green System” re-directs the used/waste water from a bathtub and/or shower to a location outside the house or other dwelling. Once the water is re-directed, it is used for providing water to lawns, trees and other plant life. Additionally, if desired the WWRS 10 can be used to re-direct waste water to a storage container for later use.

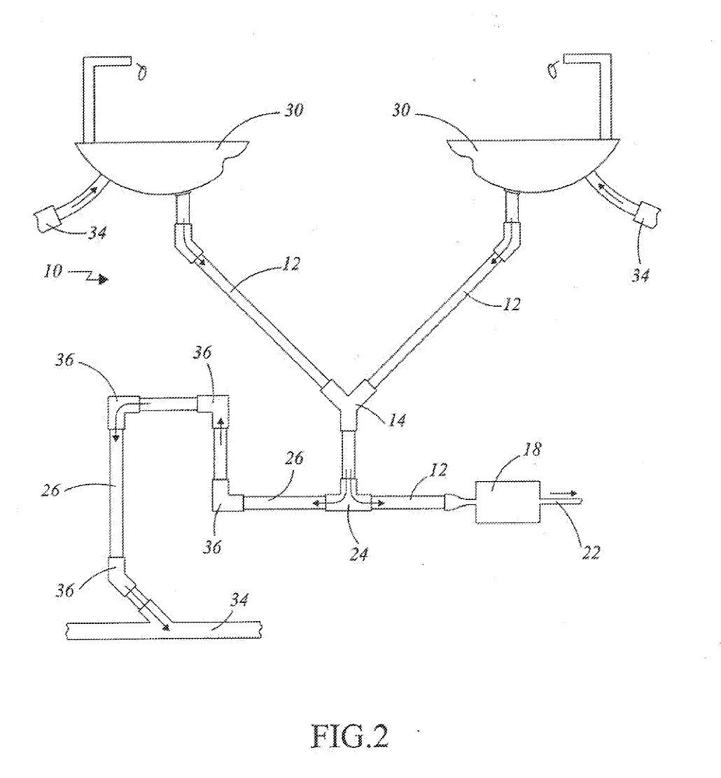

There are multiple design configurations of the WWRS 10, with each configuration determined by various factors including the size of the dwelling and the number of baths 30 that are supplying waste water into the WWRS. Each of the first two design configurations of the WWRS 10, as shown in FIGS. 1-2, is comprised of at least one first plumbing pipe 12 from a bathtub and/or shower (hereinafter “bath 30”), a fluid pump 18, a second plumbing pipe 22 from the pump 18, and an overflow plumbing pipe 26. All of the pipes can be made of plastic/PVC, galvanized metal or copper.

Water is supplied to a bath 30 from a city's main water pipe 34 or line. When the bath 30 is in use, water flows outward from a spigot or showerhead. Once the water is used, it flows out of the bath 30 through a drain to a return waste water pipe or line.

As shown in FIGS. 1-2, the water enters a bath 30 in the conventional manner. The used waste water then flows out of the drain into the plumbing pipe 12 that is attached to the drain. The water flows through the pipe 12 to a Y-fitting 14 or a T-fitting 24, each of which has two 90-degree outputs. From one of the outputs on the T-fitting 24 or Y-fitting, the waste water flows to the fluid pump 18, as shown in FIGS. 1-3, which has an internal or external motor (not shown). The size and capability of the pump 18 can vary depending on the amount of water exiting from the dwelling. A large house or apartment complex with multiple baths will require a larger, stronger pump than a house with a single bath.

From the pump 18 the waste water flows into the plumbing pipe 22, as shown in FIGS. 1-3, which leads out of the dwelling. The pipe 22 terminates at a location adjacent or near a lawn or other plant-life surrounding the dwelling. The pump 18 provides the necessary pressure to cause the waste water to adequately flow out of a spigot from where the water is directed onto the lawn or other plant-life via a conventional watering device such as a mobile sprinkler. Also, if desired, the WWRS 10 can be interfaced with a sprinkler system as a permanent install.

As shown in FIGS. 1-2, the other/second output from the T fitting 24 provides an outlet for any overflow waste water. From the second output the overflow water flows into an overflow pluming pipe 26 from where the water is then directed into the city's main plumbing pipe 34. Depending on the location of the main plumbing pipe/line 34 one or more elbow fittings 36 or couplers 38 may be utilized to direct the overflow plumbing pipe 26 to the main plumbing pipe/line 34.

The above first configuration of the WWRS 10 discloses a system for use with a single bath 30, as shown in FIG. 1. The second configuration is for when two or more baths 30 are present and additional plumbing is required, as shown in FIG. 2. For a dwelling with two baths 30, a plumbing pipe 12 will be attached to the respective drain on each bath. The two plumbing pipes 12 will converge at a Y-fitting 14 or T-fitting 24. The two pipes 12 are each attached to one of the respective ends on the fitting. Additionally, the straight section of the Y-fitting 14 can be directly attached, as shown in FIG. 2, or can be attached to a pipe which leads to the T-fitting 24. From there the water follows the same paths to either the pump 18 or to the overflow pluming pipe 26. For dwellings with more than two baths, the plumbing and routing of pipes and fittings is determined by the number of baths and the distance the waste water must travel to arrive at the pump 18 (or pumps if necessary) and then out to the lawn/plant-life or through the overflow plumbing pipe to the city main plumbing pipe/line.

Also, there are different “types” of waste water, based on the type of contamination present in the water. Examples of different waste water are identified by a color system that includes “grey water” which is the water which comes from a bathtub or shower, and “black water” which comes from a toilet. Consideration must also be made to the fact that some people occasionally urinate while in the shower. As a result of the contaminates present in grey water, which is the water utilized with the WWRS 10, a chemical de-contamination apparatus 42 is integrated into the WWRS 10. Preferably, the de-contamination apparatus 42, as shown in FIG. 1, is comprised of a liquid chemical that is introduced in-line into the WWRS plumbing. The location of the apparatus 42 in the plumbing can vary, depending on the length of (distance) and the amount of plumbing pipes that are pa-sent in the particular WWRS 10. In fact, the location is not majorly significant, as long as all the water flowing through the WWRS 10 passes through, and is treated by, the apparatus 42, prior to exiting the WWRS 10. Although a liquid chemical treatment is preferred, other types of treatment means can also be used, such as a solid chemical or a filter. The type of de-contamination apparatus and the treatment means only purpose is to insure that the water exiting from the WWRS 10 will not cause harm or damage to plant-life, humans or animals that come into contact with the water.

In order to add to the functionality of the WWRS 10, a timer switch can be utilized. The timer switch, which is electrically powered, interfaces with and regulates when the WWRS 10 is operating and for how long the WWRS 10 is in operation. The timer switch can be installed at any convenient location in a bathroom. Preferably, the timer switch is adjacent or near the bathtub and/or shower, and provides easy operation to turn on the WWRS 10 and to set the time duration the WWRS 10 is operating.

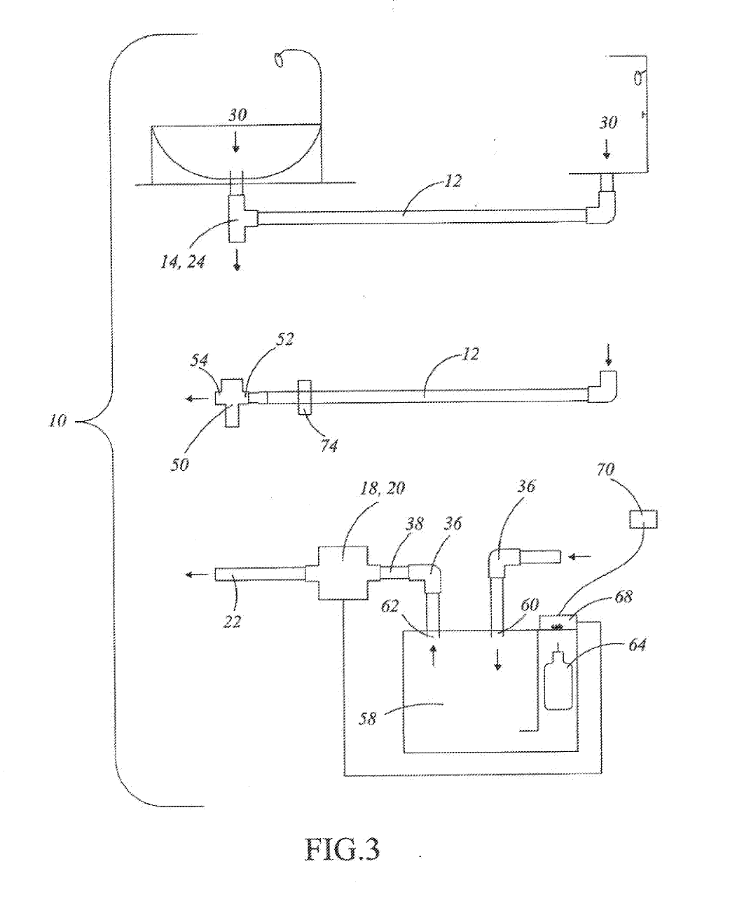

The third design configuration of the WWRS 10 incorporates and utilizes all of elements of the first and second configurations, as well as additional functional elements. In the third configuration, as shown in FIG. 3, waste water from a bath 30 structure flows into and through a first initial plumbing pipe 12 to a Y-fitting 14 or T-fitting 24. Waste water from an additional bath 30 structure flows into and through a second initial plumbing pipe 12 to the Y-fitting 14 or T-fitting 24. From the Y-fitting 14 or T-fitting 24 the waste water flows to a chemical treatment container 50 having an input 52 and an output 54. The container 50 facilitates the de-contamination of the waste water. If necessary, the diameter of the plumbing pipe(s) can be reduced to allow the pipe(s) to be connected to the input 52 and/or output 54 on the treatment container 50. There are various chemicals that can be placed into and used with the chemical treatment container 50, with chlorine being the preferred chemical. From the output 54 on the container 50 the water flows to a water treatment tank 58 having an input 60 and an outlet 62. The tank 58 functions in combination with the treatment container 50. The water enters the tank 58 via the inlet 60 and white within the tank 58 the water is treated by the chemical and de-contaminated. The chemical removes any un-wanted/harmful elements that could potentially be dangerous to plant, life (or other life such as human or animal). It is important to note that the tank 58 is not intended for water storage, rather the water simply flows through the tank 58. Located within the tank 58 is a water level indicator 64 that determines the amount of water within the tank 58.

The water level indicator is comprised of a flotation apparatus that rises or lowers depending on the water level. When the flotation apparatus rises to an upper level, the apparatus interfaces with a timer 68 that functions by means of a power source 70. Although a powered timer 68 is preferred, a mechanical timer could also be utilized. The timer 68 automatically controls the operation of the WWRS 10 based on the level of water within the tank 58.

From the outlet 62 on the tank 58 the water flows to a fluid pump 18 that is powered by an internal or external motor 20, preferably an electrical motor. From the pump 18 the water forceably flows into and through a secondary plumbing pipe 22 which terminates at a spigot placed at an outside location adjacent or near plant life. The water is applied from the spigot onto the plant life by a watering device that is attached to the spigot. Typically, the watering device is a stationary or portable sprinkler that is connected to a typical hose. While the WWRS 10 is especially effective for us in relatively smaller single-family dwellings, the WWRS 10 can be up-scaled for applications at larger locations including large mansion-like dwellings, small or large commercial buildings, or even sport stadiums. Literally any location that provides/utilizes a bath structure such as a shower or bathtub where so-called grey water is produced. It is important to note that even though the primary purpose is for watering plant life, by using the chemical treatment, the water exiting from the WWRS 10 is clean enough for many additional purposes, including consumption by humans or animals.

It should be noted that the WWRS 10 is optimally designed for use in re-directing waste water from a residential bath. Additionally, the WWRS 10 can be adapted for use with other waste water produces. For example. Jacuzzis and swimming pools, which although are not emptied frequently, when they are emptied produce a large quantity of waste water. By re-directing the waste water, other uses can be found such as watering plant-life. The waste water can also be stored for later use.

While the invention has been described in detail and pictorially shown in the accompanying drawings it is cot to be limited to such details, since many changes and modification may be made to the invention without departing from the spirit and the scope thereof. Hence, it is described to cover any and ail modifications and forms which may come within the language and scope of the claims.

1. A waste water re-directing system (WWRS) comprising at least one initial plumbing pipe exiting from a bath structure comprised of a bathtub or shower, a fluid pump, a secondary plumbing pipe exiting from said pump, and an overflow plumbing pipe, wherein waste water from said bath structure flows into and through said initial plumbing pipe to said fluid pump, wherein the water is then dumped out through said secondary plumbing pipe which terminates at a spigot placed at an outside location adjacent plant life, wherein the water is applied to the spigot onto the plant life by a watering device that is attached to the spigot wherein excess water flows into and through said overflow plumbing pipe back to a city main plumbing pipe.

2. The waste water-reheating system (WWRS) as specified in claim 1 wherein said initial and secondary plumbing pipes are made of a material selected from the group consisting of plastic/PVC, galvanized metal, or copper.

3. The waste water-redirecting system (WWRS) as specified in claim 1 wherein said fluid pump is powered by an internal or external motor.

4. The waste water-redirecting system (WWRS) as specified in claim 1 further comprising a timer that interfaces with said WWRS, wherein said timer allows a person to selectively determine the amount of time said system is in operation.

5. The waste water-redirecting system (WWRS) as specified in claim 1 further comprising a sprinkler system that is utilized in combination with said WWRS, wherein the sprinkler system is connected to said WWRS spigot to facilitate the watering of multiple locations simultaneously.

6. A waste water re-directing system (WWRS) comprising at least one initial plumbing pipe exiting from a bath structure comprised of a bathtub or shower, at least one Y-fitting, a fluid pump, a secondary plumbing pipe exiting from said pump, and an overflow plumbing pipe, wherein waste water from a bath structure flows into and through a first initial plumbing pipe to said Y-fitting, wherein waste water from an additional bath structure flows into and through a second initial plumbing pipe to said Y-fitting, wherein said first and second initial plumbing pipes converge at and are attached to said Y-fitting, wherein from said Y-fitting the waste water flows into said fluid pump, wherein from the pump the water flows into and through said secondary plumbing pipe which terminates at a spigot placed at an outside location adjacent plant life, wherein the water is applied from the spigot onto the plant life by a watering device that is attached to the spigot, wherein excess water flows into and through said overflow plumbing pipe back to a city main plumbing pipe.

7. The waste water-reheating system (WWRS) as specified in claim 6 wherein said initial and secondary plumbing pipes are made of a material selected from the group consisting of plastic/PVC, galvanized metal, or copper.

8. The waste water-redirecting system (WWRS) as specified in claim 6 wherein said fluid pump is powered by an internal or external motor.

9. The waste water-redirecting system (WWRS) as specified in claim 6 further comprising a timer that interfaces with said WWRS, wherein said timer allows a person to selectively determine the amount of time said system is in operation.

10. The waste water-redirecting system (WWRS) as specified in claim 6 further comprising a sprinkler system that is utilized in combination with said WWRS, wherein the sprinkler system is connected to said WWRS spigot to facilitate the watering of multiple locations simultaneously.

11. The waste water-redirecting system (WWRS) as specified in claim 6 further comprising at least one elbow fitting when multiple bath structures are present and utilized.

12. The waste water-redirecting system (WWRS) as specified in claim 6 further comprising at least owe pipe coupling when multiple bath structures are present and utilized.

13. A waste water re-directing system (WWRS) comprising at least one initial plumbing pipe exiting from a bath structure comprised of a bathtub or shower, a chemical treatment container having an input and an output: couplings; a water treatment tank having an inlet and outlet, an internal tuner, and a water level indicator that controls a timer; a secondary plumbing pipe; and a fluid plump that is powered by a motor, wherein waste water from a bath structure flows into and through a first initial plumbing pipe to a Y-fitting or T-fitting, wherein waste water from an additional bath structure flows into and tough a second initial plumbing pipe to the Y-fitting or T-fitting, wherein from the Y-fitting or T-fitting the waste water flows to a chemical treatment container via an input on said enclosure, wherein a chemical is placed within said container that facilitates the de-contamination of the waste water, wherein from an output on said container the water flows to a waste treatment tank, wherein the water enters said tank via an inlet and while within said tank, the water is treated by the chemical and decontaminated, wherein located within said tank is a water level indicator that determines the amount of water within said tank, wherein the water level indicator interfaces with a powered timer that automatically controls the operation of said WWRS based on the level of water within said tank, wherein from an outlet on said tank, the water flows to a fluid pump that is powered by a motor, wherein from said pump, the water forceably flows into and through said secondary plumbing pipe which terminates at a spigot placed at an outside location adjacent plant life, wherein the water is applied from the spigot onto the plant life by a watering device that h attached to the spigot.

14. The waste water-redirecting system (WWRS) as specified in claim 13 wherein said initial and secondary plumbing pipes ate made of a material selected from the group consisting of plastic/PVC, galvanized metal, or copper.

15. The waste water-redirecting system (WWRS) as specified in claim 13 wherein said fluid pump is powered by an internal or external motor.

16. The waste water-redirecting system (WWRS) as specified in claim 13 wherein the chemical that is placed into said chemical treatment container is chlorine.

17. The waste water-redirecting system (WWRS) as specified in claim 13 wherein the diameter of said plumbing pipe is reduced prior to attachment to said water treatment container.

18. The waste water-redirecting system (WWRS) as specified in claim 13 wherein the water level indicator is comprised of a flotation apparatus that rises or lowers depending on the water level.

19. The waste water-redirecting system (WWRS) as specified in claim 13 wherein the motor that, powers said fluid pump is comprised of an electric motor.

20. The waste water-redirecting system (WWRS) as specified in claim 13 further comprising mudseal to protect said plumbing pipes that are located underground.
